(19) United States
(12) Patent Application Publication
(10) Pub. No.: US 2010/0025888 A1
(43) Pub. Date: Feb. 4, 2010

(54) METHOD OF MAKING A BACK-MOLDED PLASTIC PART

(76) Inventors: Herbert BADER, Nordwalde (DE); Marcel GRUENDKEN, Gronau (DE)

Correspondence Address: K.F. ROSS P.C., 5683 RIVERDALE AVENUE, SUITE 203 BOX 900, BRONX, NY, 10471-0900, US

(21) Appl. No.: 12/512,065

(22) Filed: Jul. 30, 2009

(30) Foreign Application Priority Data
Jul. 31, 2008 (DE) 102008035956.4

(51) Int. Cl. B29C 45/14

(52) U.S. Cl. 264/279

(57) ABSTRACT

A molded part is made by cold-stretching a nonwoven web so as to rupture fibers or filaments thereof, laminating to a face of the cold-stretched nonwoven web a stretchable plastic film, and then inserting the laminated nonwoven web and film into a mold cavity with the film juxtaposed with an inner surface of the cavity and the cold-stretched web turned inward. This mold cavity is then filled a polymer melt to press the film against the inner mold surface while forcing the melt to penetrate the nonwoven web.

### FIELD OF THE INVENTION

The present invention relates to a method of making a back-molded plastic part. More particularly this invention concerns the manufacture of an intermediate laminate for making such a part.

### BACKGROUND OF THE INVENTION

An back-molded plastic part is made by back-molding a polymer melt to a laminate. The laminate comprises on its upper face a plastic film that forms a decorative surface after back-molding the laminate.

Plastic molded parts formed in this way are used, for example, as interior trim fittings for motor vehicles, for example, in the area of the doors, the pillars or the dashboard, the exterior plastic film of the back-molded laminate being visible and accessible to the user. Consequently, very high requirements are imposed in relation to the appearance of the surface, the resistance to mechanical and chemical effects, the uniformity and the resistance.

As can be deduced from US 2009/0130401, it is known from practice to provide a plastic foil for producing a plastic molded part, the plastic foil being inserted into an injection mold and subsequently back-molded with a polymer melt. The plastic foil is thus stretched and pressed against an inside surface the mold cavity. For visual reasons, an embossing, for example in the form of a leather structure, is usually provided in the plastic foil forming the surface of the plastic molded parts. The embossing can be effected both during the production of the plastic foil or subsequently by a corresponding surface structuring of the injection mold.

In order to ensure the necessary resistance of a plastic molded part formed from an back-molded foil, an adequate permanent connection must be ensured between the plastic foil and the back-molded plastic. Even if a layer of a special adhesion-promoting polymer is provided in the contact area between the plastic foil and the back-molded plastic, the adhesion between the plastic foil and the back-molded polymer substrate is frequently in need of improvement in the plastic molded parts known from the prior art. At the same time, it should be borne in mind that the plastic foil only briefly comes into contact with the hot polymer melt before the foil is pressed onto the injection mold and thereby cooled down.

A plastic back-molded part known from DE 10 2006 024 263 is formed from a laminate back-molded with a polymer compound. The laminate comprises a thermoplastic film that forms the visible surface of the plastic molded part. In order to be able to use a thermoplastic film which is as thin as possible, it laminated with a material web having an open structure. A nonwoven web, fabric, fibers, felt, textile or a type of wool can be provided as material web. The additional material web is used for reinforcement of the thermoplastic film so that it can be made with a comparatively small thickness. Since the additional material web laminated with the thermoplastic film according to the embodiment known from DE 10 2006 024 263 is provided as reinforcement, this laminate overall exhibits poor stretchability which is substantially determined by the additional material web. As a result of the high resistance during stretching of the laminate during the back molding in an injection mold, particularly in the case of complex geometries which require strong elongations and curvatures, there is a risk of crack formation with the result that the thermoplastic film provided as a decorative surface can be locally damaged. In addition, there is also the risk that if the laminate is ripped, the polymer melt will pass through the cracks formed with the result that the plastic molded part becomes unusable.

Laminates for hygiene articles comprising a nonwoven web and a plastic film laminated therewith are known from U.S. Pat. No. 5,382,461, U.S. Pat. No. 7,501,361, U.S. Pat. No. 5,914,084, U.S. Pat. No. 6,114,263, and U.S. Pat. No. 6,383,431. The nonwoven web is used in hygiene articles in order to achieve a textile-like touch, a soft surface as well as good breathing activity.

### OBJECTS OF THE INVENTION

It is therefore an object of the present invention to provide an improved method of making a back-molded plastic part.

Another object is the provision of such an improved method of making a back-molded plastic part that overcomes the above-given disadvantages, in particular that ensures a secure and permanent connection between the laminate and the back-molded plastic even in the case of complex geometries of a plastic molded part.

### SUMMARY OF THE INVENTION

A molded part is made by cold-stretching a nonwoven web so as to rupture fibers or filaments thereof, laminating to a face of the cold-stretched nonwoven web a stretchable plastic film, and then inserting the laminated nonwoven web and film into a mold cavity with the film juxtaposed with an inner surface of the cavity and the cold-stretched web turned inward. This mold cavity is then filled a polymer melt to press the film against the inner mold surface while forcing the melt to penetrate the nonwoven web.

Thus during the back molding, the polymer melt can penetrate directly into the nonwoven web so that a secure and permanent connection between the laminate and the back-molded plastic is achieved during a rapid solidification of the polymer melt.

Unlike in the embodiments of a laminate for the formation of back-molded plastic molded parts known from the prior art, which is provided, for example, as an open structure formed from a nonwoven web as reinforcement and which leads to a considerable stiffening of the laminate, the laminate provided according to the invention is distinguished by a good stretchability. The stretchability of the originally stiff nonwoven web is achieved by cold-stretching the nonwoven web before the laminating with a stretchable plastic film. This way the material structure is partially overstretched and partially destroyed, principally be rupturing at least a portion of the fibers or filaments forming the web. A laminate can thus be provided in which the nonwoven web makes it possible to achieve a very good and permanent bonding to a back-molded plastic but on the other hand does not excessively adversely affect the stretching properties of the entire laminate.

Within the scope of the invention a prefabricated plastic film is supplied for the laminating with the cold-stretched nonwoven web, the lamination can be carried out without restriction by adhesive bonding, for example, by means of a hot-melt adhesive or directly through the action of pressure and/or temperature. The plastic film can be designed as a mono- or multilayer film in which the fibers of the nonwoven web preferably penetrate at least partially into the adhesive or the adjoining molten film layer during the lamination. The lamination is preferably carried out without fusing or at least without complete fusing of the individual fibers of the nonwoven web.

According to an embodiment, in order to form the plastic film, a single or multi-layer thermoplastic film emerges from an extrusion nozzle and is guided therefrom over a cooling roller. The thermoplastic film is directly brought in contact with the cold-stretched nonwoven web after the extrusion. In the contact zone, the material of the thermoplastic film can thereby penetrate to a certain extent into the nonwoven web before solidifying so that a very high composite strength is achieved without using an additional adhesive. According to a preferred further embodiment the thermoplastic film and the nonwoven web are guided through a gap between surfaces of the cooling roller and a smoothing belt so the nonwoven web engages the cooling roller and the thermoplastic film engages the smoothing belt. The plastic film formed due to the solidification of the thermoplastic film in the gap between the cooling roller and the smoothing belt is characterized by a very high-quality and uniform surface on the side opposite the nonwoven web. The formation of a plastic film due to solidification of a thermoplastic film in a gap between a cooling roller and a smoothing belt is generally also designated as sleeve-touch method.

Within a particularly preferred further embodiment the softening temperature of the nonwoven web lies above the extrusion temperature of the thermoplastic film so that the individual fibers or filaments of the nonwoven web are not fused or at least not completely fused and are reliably anchored in the plastic film formed.

Starting from the basic idea of the invention to allow a good stretchability of the laminate by cold stretching of the nonwoven web, various possibilities are obtained.

According to a first alternative, the nonwoven web preferably drawn from a roller is cold stretched completely and substantially uniformly in the direction of movement and the transverse direction. The laminate formed in this way is distinguished by uniform stretching properties which substantially correspond to a material formed exclusively from the plastic film of the laminate. The laminate can therefore be used instead of the films provided according to the prior art to form back-molded plastic molded parts without any special adaptation or conversion of the injection molded part method being required. According to the films known from the prior art for the formation of back-molded plastic molded parts, the laminate provided according to the invention has a maximum stretchability of usually at least 50%, preferably at least 100%, particularly preferably at least 200%. Compared to a material formed exclusively from the plastic film of the laminate, the force required for stretching the laminate due to the additional layer of nonwoven web is preferably increased by a maximum of 50%, particularly preferably by a maximum of 25%.

According to a second embodiment, the nonwoven web is merely drawn in one direction before the laminating with the stretchable plastic film. This second embodiment is based on the discovery that particularly during the manufacture of elongated plastic molded parts, for example, the cladding of an A, B or C pillar of a motor vehicle, the stretching of the laminate takes place principally in one direction so that a slight stretchability of the laminate is only required in this direction. If, for example, the nonwoven web is only cold-stretched in the transverse direction, the laminate formed exhibits anisotropic stretching properties. In this case, the laminate is comparatively stiff in the direction of movement so that during handling of the laminate, particularly during rolling and unrolling at increased tensile forces damage and in particular tearing can be avoided so that an appreciable improvement is achieved compared with the conventional films known from the prior art.

According to a third embodiment, the nonwoven web is cold stretched only in sections or locally with different strength in the direction of movement and/or the transverse direction. The activation of the nonwoven web due to the cold stretching is then effected taking into account the precise form of the plastic molded part to be produced. The section of the laminate provided for forming a plastic molded part should then be inserted initially with the locally differently cold-stretched nonwoven web in precise predetermined alignment in the injection mold. Due to a locally different cold stretching of the nonwoven web, it is surprisingly possible to precisely control the stretching behavior of the laminate during the injection molded part. Thus, for example, areas in which a uniform high deformation is provided can be configured to be easily stretchable by means of a correspondingly strong local stretching of the nonwoven web. However, in order to avoid local tearing of the laminate during injection molding of a part with small radii and edges, it is also possible to produce an elevated strength by at most slight prestretching of the nonwoven web, the surrounding areas then being activated in such a manner that overall a more uniform stretching takes place below the loading limit.

In order to stretch the nonwoven web before laminating it to the plastic film, stretching rollers or stretching frames can be provided without restriction. It is particularly preferable if the nonwoven web is guided through a roll gap between intermeshing contoured rollers for the cold stretching. In order to cold draw the nonwoven web uniformly, for example, in the transverse direction, for example, two intermeshing shaft-like rollers can be provided, Furthermore, a locally different stretching can also be achieved by a non-uniform contouring.

The back molding with the polymer melt is preferably done in such a manner that the individual fibers of the nonwoven web are not fused or at least are not completely fused.

The plastic molded part can have a structuring, for example, in the form of a leather pattern, on the surface formed by the plastic film. Such a structuring can be produced both by back molding of the laminate due to a corresponding contouring of the injection mold or during production of the laminate.

Within the scope of the present invention, the nonwoven web is formed from plastic fibers and is provided, for example, with a weight per unit area between 10 and 60 g/m³, preferably between 15 and 30 g/m². The polymer composition of the nonwoven web is not restricted within the scope of the present invention. Preferred, however, are materials having a high strength in order to ensure a secure connection between the laminate and the back-molded plastic. For example, a point-bonded spunbond nonwoven of polyester is suitable. In addition, as many fibers of the nonwoven web as possible should be anchored in the adjoining layers of the plastic film and the back-molded plastic, the most extensive possible penetration of the nonwoven web through the back-molded plastic and the material of the plastic film being advantageous. In this respect, fraying of the nonwoven web and alignment of individual fibers can be achieved in a particularly advantageous manner by the cold stretching.

The plastic film of the laminate should be selected in particular taking into account its surface properties and suitability as decorative film. Materials that are resistant and scratch-proof are preferred. Depending on the intended use of the plastic molded part formed, a specific feel or hand is frequently required, for example, a matt, paper-like surface (soft-touch effect). The plastic film can be formed, for example, from thermoplastic polyolefin (TPO) or thermoplastic polyurethane (TPU). Within the scope of the invention, the plastic film can also be configured to be multilayered. Thus, for example, in order to improve the adhesion between the nonwoven web and the plastic film an adhesion promoter layer is provided on the side of the plastic film facing the nonwoven web. A copolyamide or a polyether(ester) block amide (TPE-A), for example, is suitable as adhesion promoter. The thickness of the film is typically between 100 μm and 700 μm, preferably 150 μm to 500 μm, particularly preferably 200 μm to 350 μm. In order to improve the surface properties, a coating, for example with a varnish can also be provided. The side of the film provided as the decorative surface preferably has a high scratch resistance and a hardness between 65 and 95 Shore A (according to DIN 53505: 2000-08). The film should overall have a good stretchability.

For example, polypropylene (PP), acrylonitrile butadiene styrene (ABS), polycarbonate (PC), polyamide (PA), thermoplastic elastomer (TPE) or a mixture of at least two of the polymers is suitable as polymer melt for back-molding the laminate. Furthermore, reinforcing materials such as, for example, glass fibers, natural fibers and carbon fibers or fillers are provided to increase the strength or reduce the manufacturing costs.

### BRIEF DESCRIPTION OF THE DRAWING

The above and other objects, features, and advantages will become more readily apparent from the following description, reference being made to the accompanying drawing in which:

FIG. 1 is a schematic view of an apparatus for carrying out the method of this invention;

FIG. 1a is a perspective view of a detail of the apparatus of FIG. 1;

FIG. 2 is a schematic view of another apparatus for carrying out the method of this invention;

FIGS. 3a and 3b are large-scale sections through the laminate made by the machines of FIGS. 1 and 2, respectively; and

FIG. 4 is a section through an injection mold with the laminate of this invention.

### SPECIFIC DESCRIPTION

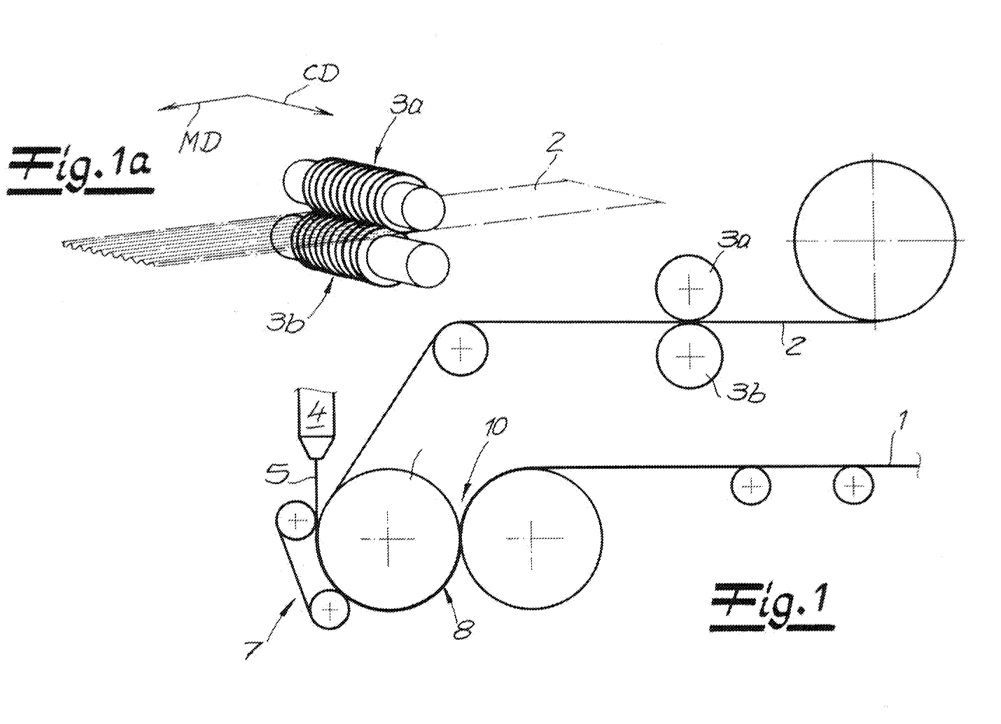

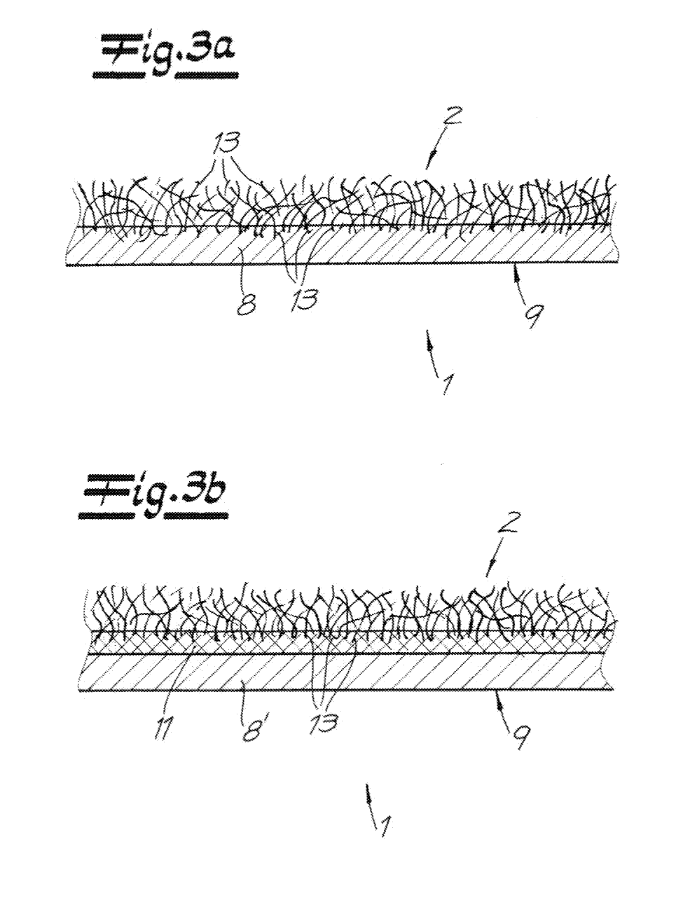

As seen in FIG. 1 shows a preferred embodiment of the method for producing a laminate 1. A nonwoven web 2, for example, a point-bonded spunbond nonwoven of polyester having a weight per unit area between 15 and 30 g/m³, is guided through a roll gap formed by intermeshing contoured rollers 3a and 3b and is thereby cold-stretched so as to partially destroying the material structure, that is to rupture some of the filaments and leave filament ends 13 (FIGS. 3a dn 3b) projecting from both faces of the web 2. Depending on the shape of the intermeshing rollers 3a and 3b, a merely sectional or complete and preferably substantially uniform cold stretching of the nonwoven web 2 takes place in the direction of travel MD and/or a transverse direction CD.

After the cold stretching, the nonwoven web 2 is brought into contact with a molten thermoplastic film 5, for example TPU, emerging from an extrusion nozzle slit 4. The thermoplastic film 5 and the nonwoven web 2 subsequently pass through a gap between a cooling roller 6 and smoothing belt 7 so that the thermoplastic film 5 is pressed and penetrates into the nonwoven web 2 to a certain extent and subsequently solidifies to a plastic film 8 as it is cooled by the roller 6. Due to the solidification of the thermoplastic film 5 on the smoothing belt 7, a plastic film 8 having a very uniform and high-quality surface 9 compared with the nonwoven web 2 is produced. a three-dimensional structuring of the smoothing belt 7 forms a structured 9, here a leather pattern, on the lower or outside face of the film 8 while it is still soft. The laminate 1 formed from the nonwoven web 2 and the plastic film 8 is subsequently guided through another roll gap 10. This film 8 is quite thin and readily deformable.

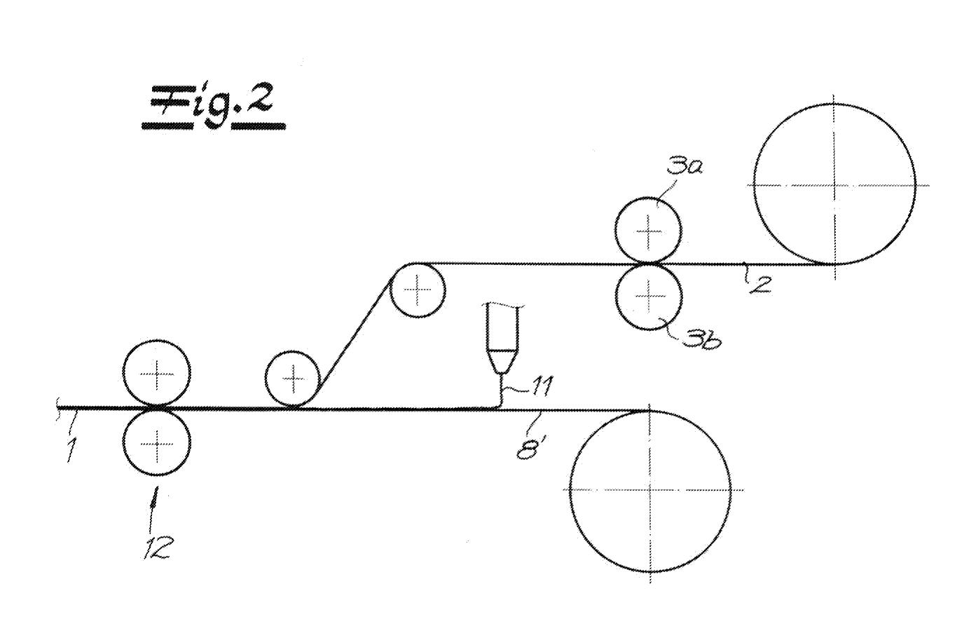

FIG. 2 shows an embodiment of the method according to FIG. 1. Here the nonwoven web 2 is pulled off a roll as before and guided through contoured rollers 3a and 3b for cold-stretching and fraying, turning the web 2 from an initially fairly smooth and structurally somewhat strong material into one that is soft fuzzy and that can be deformed very easily. Furthermore, a prefabricated plastic film 8′ is supplied, but here coated with a hot-melt adhesive 11 and joined to the nonwoven web 2 by laminating rollers 12. In a modification of the method shown in FIG. 2, a direct joining of the nonwoven web 2 and the plastic film 8′ can be achieved through the action of pressure and/or temperature as in FIG. 1.

FIG. 3a shows the laminate 1 fabricated according to the method from FIG. 1. The structure of the nonwoven web 2 is partially destroyed by the cold stretching in that filaments are broken and broken free ends 13 project upward and downward from the web 2. Due to the associated reduction in the strength of the nonwoven web 2, this is readily stretchable and deformable. Since the nonwoven web 2 is brought into contact with the thermoplastic film 5 during the laminating and the plastic film 8 is formed due to solidification of the thermoplastic film 5, a plurality of the fiber ends 13 of the nonwoven web 2 have penetrated into the plastic film 8, with the result that a very high bonding strength is achieved. The fact that a plurality of the ends 13 is aligned due to the cold stretching also contributes to a high strength.

FIG. 3b shows a laminate produced according to the method from FIG. 2, wherein unlike FIG. 3a, the nonwoven web 2 is joined to the plastic film 8′ by a hot-melt adhesive 11. Good bonding is achieved in this case in particular since the hot-melt adhesive 11 has penetrated into the nonwoven web 2 and surrounds some of the filament ends 13. Due to the cold stretching of the nonwoven web 2 and the associated partial destruction of the material structure, a slight stretchability of the laminate 1 can be achieved. When the nonwoven web 2 is completely cold-stretched in the direction of movement MD and the transverse direction CD, the laminate 1 according to the invention exhibits comparable stretching properties to the films known from the prior art for the formation of back-molded plastic parts.

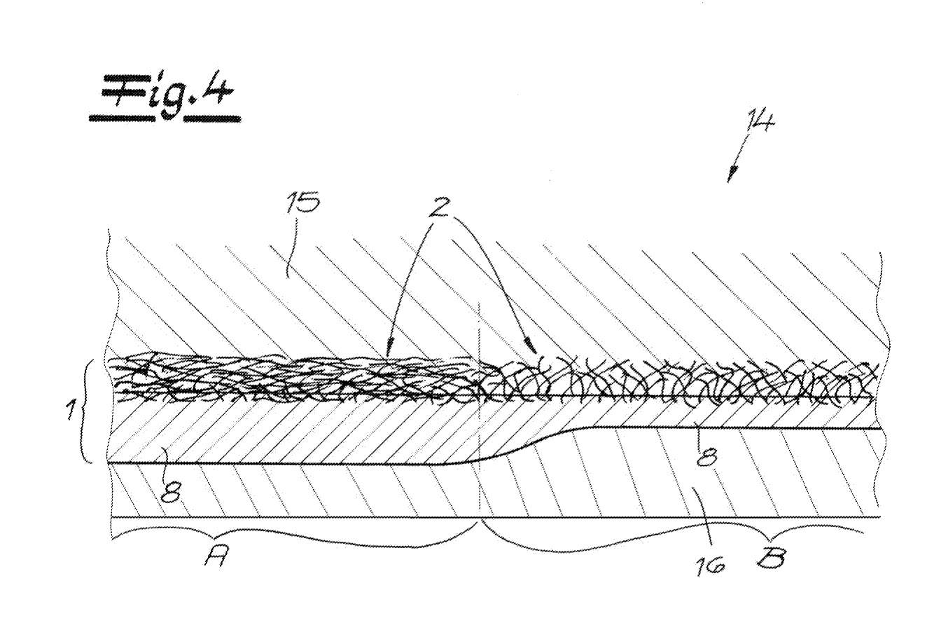

Within the scope of the present invention, however, it is possible to specifically control the stretching behavior of the laminate 1 by a locally different cold stretching of the nonwoven web 2 in a particularly advantageous manner. FIG. 4 shows as an example in this respect the section of a plastic molded part 14 formed in a mold 16 from the laminate 1 and a back-molded plastic 15. According to FIG. 4, the laminate 1 has a first region A in which the nonwoven web 2 was not stretched before the laminating with the plastic film 8. In region A the nonwoven web 2 has substantially the original structure. Since the nonwoven web 2 was not cold-stretched in region A, the entire laminate is comparatively stiff there and has not been deformed or has only been slightly deformed during the back molding with the plastic 15, with no ends 13 projecting from its faces. In region B of the laminate 1, the nonwoven web 2 has been cold-stretched before laminating with the plastic film 8 with partially destruction of the material structure. Accordingly, this slightly stretchable region of the laminate 1 due to the activation of the nonwoven web 2 has stretched severely during the back molding with the plastic 15 so as to press tightly against the inner surface of the cavity of the mold 16, which can be identified particularly from the reduction in the thickness of the plastic film 8.

### Illustrated Embodiment

A laminate was produced, consisting of a 335 μm thick film of a thermoplastic polyurethane (TPU), a nonwoven having a weight per unit area of 25 g/m² and a copolyamide adhesion promoter layer between film and nonwoven. The nonwoven was cold stretched before application by means of a roller arrangement of profile rollers having an activation depth of about 3 mm. For comparison a laminate of the above-described materials was fabricated without previous cold stretching (activation) of the nonwoven. The mechanical properties of the laminate according to the invention and those of a comparative material and of a 335 μm thick TPU film are compared in the following table. The stretching of the laminate can be significantly improved due to a previous activation (cold stretching) of the nonwoven. The breaking elongation measured for the laminate according to the invention is comparable to the breaking elongation of the films. Furthermore, a lower force must be applied to elongate the laminate according to the invention by 50 to 250%.

| | | Laminate | Laminate due to | |
|---|---|---|---|---|
| | | with nonwoven | cold stretching | |
| | | (comparative | of pre-treated | TPU |
| Property | Unit | material) | nonwoven | film |
| Breaking elongation | % | 1200 | 1700 | 1700 |
| Force at 50% | N | 40 | 25 | 6 |
| elongation | | | | |
| Force at 100% | N | 40 | 25 | 12 |
| elongation | | | | |
| Force at 250% | N | 40 | 25 | 18 |
| elongation | | | | |

We claim:

1. A method for producing a molded part, the method comprising the steps of:
cold-stretching a nonwoven web so as to rupture fibers or filaments thereof;
laminating to a face of the cold-stretched nonwoven web a stretchable plastic film;
inserting the laminated nonwoven web and film into a mold cavity with the film juxtaposed with an inner surface of the cavity and the cold-stretched web turned inward;
filling the mold cavity with a polymer melt and thereby pressing the film against the inner mold surface while forcing the melt to penetrate the nonwoven web.

2. The molding method defined in claim 1 wherein the polymer melt is heated to a temperature below a softening point of the fibers or filaments forming the nonwoven web.

3. The molding method defined in claim 1 wherein the film is laminated to a face of the web by applying a hot-melt adhesive to the face of the web or a face of the film and then pressing the web and film together.

4. The molding method defined in claim 1 wherein the film is laminated to a face of the web by extruding the film and, while the film is still hot and soft, pressing it against the face of the web.

5. The molding method defined in claim 1 wherein the film is laminated to a face of the web by pressing the film against the web while heating the film.

6. The molding method defined in claim 1 wherein after laminating the web to the film but before inserting the laminated-together film and web into the mold cavity the web and film are pressed together between two moving surfaces.

7. The molding method defined in claim 6 wherein the moving surface engaging the film has a structured surface and forms a pattern on the film.

8. The molding method defined in claim 6 wherein the moving surface engaging the web is cooled.

9. The molding method defined in claim 8 wherein the nonwoven web has a softening point above a temperature of the film.

10. The molding method defined in claim 1 wherein the nonwoven web is cold-stretched completely in or transverse to a travel direction.

11. The molding method defined in claim 1 wherein the nonwoven web is cold-stretched between a pair of rollers having surfaces with meshing interfitting ridges.
